(19) United States
(12) Patent Application Publication
(10) Pub. No.: US 2001/0027476 A1
(43) Pub. Date: Oct. 4, 2001

(54) Fluid drilling system with drill string and retro jets

(76) Inventor: Yoko Kido, Tochigi-ken (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/746,674

(22) Filed: Apr. 23, 2001

(30) Foreign Application Priority Data
Dec. 24, 1999 (JP) 11-377081

(51) Int. Cl. G06F 15/16; G06F 17/00; G06F 7/00

(52) U.S. Cl. 709/206; 707/104.1

(57) ABSTRACT

To collect “information” on the brief contents of the magazines, sales promotion information of new CD or video discs, news and TV broadcasting programs arising and varying one after another, by a means to collect more than a single information or the contents of publications arisen or made public regularly or irregularly, a means to retrieve and summarize more than once more than a single specific word or phrase registered in advance out of more than a single information collected by the above-mentioned collection method, or a means to extract and summarize more than once more than a single characgtor registered in advance, and a means to distribute more than once information summarized by the above-mentioned retrieval or extraction and summarization method.

### BACKGROUND OF THE INVENTION

1. Field of the Invention

New information providing services to register the key words in advance and to retrieve “active information” such as those which are renewable like the list of contents of the magazines, sales information of new products (books, CD's, video items, other items), news, etc. and to provide such information by “e-mail”.

2. Description of the Related Art

There was no other way for the users but to spend lots of time and energy for retrieval and investigation of information which may arise and vary daily as in the contents of any magazines, the sales of CD or video items, news and television programs. Thus, an invention of a method to collect these information simply has been long awaited.

As the prior art, for example, there is a charged delivery service to distribute the list of the contents of the magazines, where each user has had to program its own computer to retrieve specific words or phrases out of the contents of the magazines. And there is a method to buy and look through daily newspapers or TV program magazines fully for information of the broadcasting schedules, programs, etc. There is an electronic magazine on the internet called “Mail Magazine”. And as an information retrieval method, there is a system called “Retrieval Engine” to retrieve many home pages on the internet by key words. And as a method to check and evaluate advertising effect, there is a method of marketing analysis by an enquete searching to the readers.

For example, in the charged information services to distribute the contents of magazines, all the contents of more than a single magazines are distributed, in which case it was necessary for the users to spend lots of time and energy to look through all the contents of magazines visually and fully or go into retrieval by the computer programming by themselves in order to get more useful information for them through extraction of specific articles and words out of the contents of the magazines.

For example, in the method to receive information on the TV broadcasting schedules, programs, etc., the users themselves had to buy and look through the newspapers and magazines with information on TV programs daily and to make a retrieval by inputting all information to the computer. It was necessary for them to spend lots of time and energy for this purpose.

For example, in the electronic magazines called “Mail Magazines” on the internet, same information was distributed to all the readers. For this reason, it was not possible to distribute more useful individual information specifically selected for each users, that is, no different information was distributed for each users.

For example, in the system called “Retrieval Engine” to retrieve many home pages on the internet by key words as information retrieval method by key words, the users had to input key words every time on the home pages of “Retrieval Engine” in case of necessity and do the retrieval by themselves. For this purpose, the said retrieval had to be repeated each time in order to obtain up-to-date information, and eventually has caused the users to spend lots of time and energy, and many omissions and mistakes in retrieval have been made.

For example, in the marketing analysis method by enquete searching to the magazine readers and consumers for checking and evaluating advertising effect, the result obtained was nothing but that of the group of the people which were the readers or commodities purchasers and those who wished and had a time to reply to the enquete search. That is why it was difficult to make the correct evaluation of the advertising effec.

### SUMMARY OF THE INVENTION

New services to register key words in advance and retrieve and distribute by “email” “active information” which is renewed one after another like the contents of the magazines, sales information of new products (books, CD's, video items, other items), news, etc.

For example, the users register in advance those key words which always interest them such as performers' and writers' names, etc. Service distributors make a retrieval of information by the registered key words and distribute its result accordingly whenerver it arises. Since the key words are registered in advance, daily retrieval is not necessary to be done by “Yahoo”, etc. and the result is distributed by “e-mail” daily, which makes it very easy to collect information with “passive attitude”. The publishers and sales promoters of new products can take advantage in notifying and advertising their new products not only to the unspecified majority but also to those sure potential customers who have definite demand with their key words accordingly. Service distributors are able to make profits from the users, information distributors, advertisers, etc.

This invention has been made to solve the above subject, and provides a means to collect more than a single information or the contents of publications which have arisen or have been made public regularly or irregularly, a means to retrieve and summarize more than once more than a specific word registered in advance out of more than a single information collected by the above-mentioned method or a means to distribute more than once information collected by the above-mentioned menthod means for the retrieval, extraction and summarization.

According to the first modality of this invention, a means to collect more than a single information or the contents of publications which arise or are made public regularly or irregularly, a means to retrieve and summarize more than once more than a single word registered in advance out of more than a single information collected by the said collection method or a means to extract and summarize more than once more than a single character, and a means to convey more than once information collected by the above-mentioned means for retrieval, extraction and summarization, are applied, for which a computer, e.i. an eletronic computer is applied partially or fully.

Next, more than a single retrieval and extraction of more than a single word or phrase registered in advance is done, and more than a single extraction and summarization of more than a single character registered in advance is done. And information summarized is distributed to individual persons and the groups/organizations more than once.

Thus, individual persons or group/organizations are able to make a choice easily and properly of useful information out of publications and information containing really necessary keywords without retrieving visually or extracting by specific programs. And through distribution of different information to individual persons or group/organizations, useful information can be disdtributed selectively, easily and adequately. Moreover, summarized information can easily be used for speedy and effective marketing or demand forecast of information, publications, merchandises, or services. Furthermore, for example, by this summarization method applied for translation into foreign language, it becomes possible to introduce, notify, and advertise simply and speedily information or publications issued in mother languages to the foreign countries.

Moreover, by extracting and summarizing information or the contents of publications by a charactor at the side of non-distributors or distributors, it becomes possible to obtain very useful information and services for non-distributors or distributors simply and speedily.

According to the second modality of this invention, a computer is applied as the above-stated means for retrieval, extraction, and summarization, and as a means to distribute more than once information summarized by the said method, the computer, or electronic mail or television for cable or wireless data transmission, or cable or wireless mobile information terminals or telephones, and mobile phones as mobile information terminals are applied.

As a means for retrieval or extraction and summarization and transmission, it becomes possible to retrieve and extract, summarize and transmit information simply and properly without any mistake with application of a computer and its software to work thereon. And it becomes possible to distribute information simply and properly without any mistake by electronic mails or televisions or home pages or mobile information terminals or telephones or mobile phones as a transmission method.

According to the third modality of this invention, a means to obtain information for retrieval or extraction or the publications themselves or a means to obtain further information or to make use of services based on information or the publications.

Since information retrieved, extracted and summarized from original information or publications is prepared originally for obtaining original information or publications themselves, having a means to obtain original information or publications themselves enforces usefulness of summarized information and makes it possible to obtain original information or publications simply and speedily.

According to the forth modality of this invention, it becomes possible for individual persons or groups/organizations who receive distribution of summarized information to obtain useful information simply and speedily. Thus, the system distributors of this invention and business transaction method can obtain profit in compensation. Or the distributors of information or publications are able to notify and advertise their own information or publications simply and speedily to many individual personss or group/organization simultaneously. The system distributors of this invention and business transaction method can obtain profit in compensation thereof.

According to the fifth modality of this invention, it becomes possible for advertisement or publicity providers to advertise their own information, products or service simply and speedily to many individual persons or group/organizations by attaching to or describing its advertisement or publicity on information to be distributed. The system distributors of this invention and business transaction are able to obtain profit in compensation thereof.

According to the sixth modality of this invention, it becomes possible to transmit information simple and properly without any mistakes by applying a computer software for carrying out full or partial information retrieval, extraction, summarization and distribution.

### BRIEF DESCRIPTION OF THE DRAWINGS

FIG. 1: Model drawing of transaction system method showing a preferred embodiment.

FIG. 2: An e-mail example to be delivered as a preferred embodiment.

Explanation of Signs: 1. Service Users (computer, mobile phone); 2. Service Distributors; 3. Publishers (Information Distributors, Publishing Companies,Writers, Ordinary People, etc.); 4. Advertisement Distributors (Publishing Companies,Enterprises, etc); 5. Information Distributors, Purchasers, etc.; 6. Payment of Information Publication Fee, etc.; 7. Information Collection (by purchase, data presentation,etc.); 8. Information Retrieval and Summarization by customer's keywords (with an application of software); 9. Distribution of Summarized Information (mail, audio, etc.); 10. Payment of Advetising Fees; 11. Publication of Advertisement; 12. Information Distribution by electronic mail, audio, etc. (linking with retailers, with ad); 13. Payment of Service Usage Fee; 14. Registration of Key Words; 15. Ordinary Enterprises (ordinary enterprises, ad agents, etc.); 16. Payment of Summarized Information Usage Fee; 17. Presentation of Summarized Information; 18. Purchase of Commodities and Services; 19. Book Stores, Record Shops, etc.; 20. Payment of Commission.

### DETAILED DESCRIPTION OF THE PREFERRED EMBODIMENT

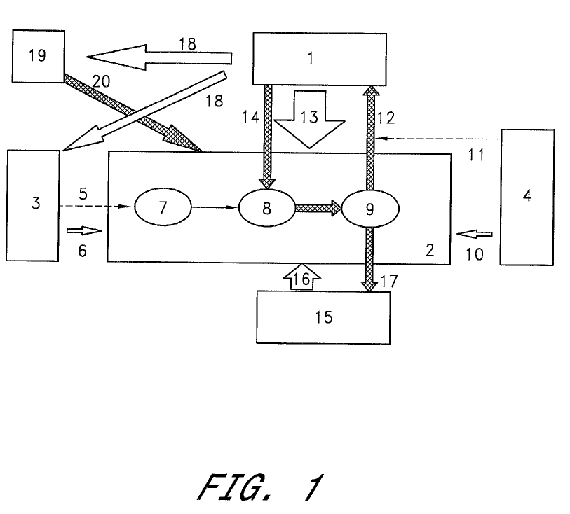

FIG. 1 shows an example of a preferred embodiment of this invention, which is the model diagram of transaction system or services based on the system of this invention.

In the example of a preferred embodiment, as more than a single information or the contents of magazines which have arisen or have been published regularly or irregularly and sold in the market, the contents of publications issued periodically and information on the sales of compact disc record of music software is applied. In the example of a preferred embodiment, as a means to collect the above-stated contents and information, presentation by publishing companies, contribution by ordinary people, purchase from the retail shops are applied. All the contents and information collected thereby are electronized into a computer. As a means for making more than a single retrieval and summarization of more than a single specific word or phrase registered in advance out of collected information, or as a means to extract and summarize more than once more than a single character registered inadvance, retrieval programming software made to work on a computer is applied. As a means to transmit information summarized by the above-stated retrieval means more than once, a programming software made to work on a computer and e-mail for transmission to a computer or mail to mobile phones or audio to mobile phone are applied. As a means to obtain information or publications themselves or a means to receive further information or make use of services based on the said information or publications, internet link or advertisement with internet addresses of internet bookstores and record shops described in the distribution mail is applied. In this example of a preferred embodiment, charges or fees for information publication and advertisement are collected from magazine publishers, advertisers on the delivered e-mail, and internet book and record shops, and non-distributors of information are offered free of charge.

As shown in the FIG. 1, firstly service users or non-distributors of information register with service providers their own words or phrases that interest them, or their own character like hobbies, favorites, and residential areas, and their own physical and spiritual characters as their key words for retrieval. This registration is done through the means of communication such as e-mail, conventional mail, facsimile, or verbally. The registered key words are, for example, usually the words or names of persons which may continuously interest the users.

First of all, service distributors collect the contents of magazines and sales information of compact disc record as music soft wares through presentation from the publishers, contribution by the ordinary people or purchase from the retail shops.

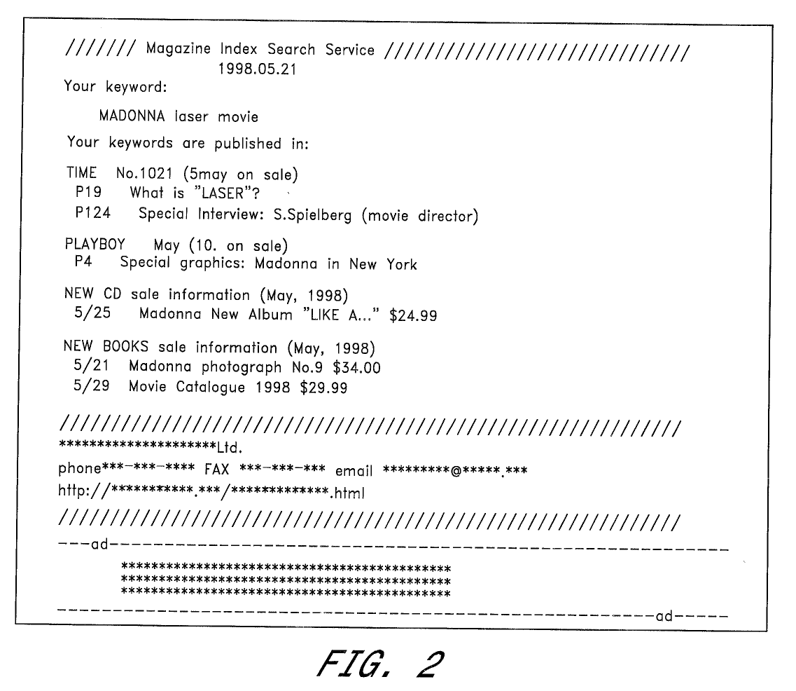

Next, the key words for each users are retrieved, edited, and summarized from the collected information data. And retrieved information is classified, extracted and summarized to meet the character of each users. Summarized information is shown in the FIG. 2. In case of the magazines, the name of magazine, number of issue, the date of sales, the list of contents, the related pages, etc. are described. For the sales information soft wares of compact disc record, the name of singer, the title of song, the date of sales, the retail price, categorical classification, kind of records, single or album, etc. For these works, a retrieval programming software made for the purpose is applied.

In the character summarization, sales information of new products, etc. are described to meet the hobbies, favorites, etc. of the users. Advertisement to be included in the distribution mail is also selected to meet the character as shown in the FIG. 2.

And for these works, a retrieval programming software made for its purpose is applied. And summarized information is distributed to the computers or mobile phones of each users through e-mail, letter information, or verbally, where advertisement or announcement of internet book or record shops is also included in the distribution, and since summarized information varies from users to users, the contents of electronic data, letter information or audio contents vary as well. These works are repeated every time upon publication of magazines, sales of new products or arising of information.

Service users have their key words registered in advance which interest them continuously. This is why users do not need to retrieve every time in necessity. Since service distributors retrieve the users' individual keywords automatically on behalf of users out of the contents of magazines and information summarized, users are able to retrieve information quite easily and speedily, and thus enjoy its high convenience. It is also useful as advertisement or information that may suit the hobbies or favorites of each users is provided. The users can buy any items at the actual retail shops or at internet book or record shops based on information distributed. In case of making use of any book or records shops on the internet, users have only to go through the addresses provided on the internet and eventually are able to buy the goods quite easily and very conveniently without looking for the addresses and visiting actual location of the book or record shops.

Since turnover can be expected by the owners of the above-mentioned retail shops, bookstores, advertisers as a result of contributing information to the users, they pay commissions or information publication fees or advertising fees to the service providers. And the magazine publishers pay information publication fees as they have been assured of the information distribution of their own magazines to the sure customers in demand for the products.

Information retrieved and summarized is provided to the advertising agents as data for grasping the demand in marketing, through which advertising agents and publishers are able to grasp the tendency or demand the customers and eventually pay information fees.

In this example of a preferred embodiment, retrieval is used as a means to distribute different information to each users, but even other method, as long as it distributes different information to each users, does not damage the effect of this invention.

In this example of a preferred embodiment, the contents of the magazines are applied as information for retrieval, but the effect of this invention is not damaged even by distributing all or some of the contents out of the plural numbers of magazines in the subject or by applying any active information which may arise or vary one after another such as the indexes, full pages and pictures of ordinary books and newspapers, sales information on all kinds of publications, books, video soft wares, DVD soft wares, laser disc soft wares, events information, information on the program, performers, producers of radio broadcasting or cable broadcasting or internet broadcasting, information on the commercial ad broadcasting, information on the home pages, up-to-date information thereof, information on the market share prices, commodity prices, weather, the sales of new products, information on the companies, whereabouts and news.

In the example of a preferred embodiment for retrieving information on the program of television broadcasting, radio broadcasting, cable broadcasting and internet broadcasting, wireless or cable information transmission to the internet internet receiving equipment is used as information contribution method. And as a means to make use of further services based on the above information collected, internet broadcasting receiving systems such as internet television and computers, etc, audio and video recording systems such as video tape recorders, DVD recorders and hard disc recorders, and receiving, video recording or audio recording systems, and their reservation systems or related functions are applied. With these equipment or functions, information on television broadcasting programs, radio broadcasting, cable broadcasting and internet broadcasting programs is applied as retrieval subject and actual retrieval, extraction, summarization and distribution to make automatic or manual receiving or video recording or audio recording and its reservation. Following the above methods, the users are able to obtain easily and speedily any individual useful information summarized on the broadcasting programs of television, radio, cable and internet, and to receive, make video and tape recording as well as reservation of the television, radio, cable and intgernet broadcasting programs thereof.

In this example of a preferred ambodiment, active information, i.e. information which arises or varies one after another such as the contents of the periodically issued magazines sold in the market, sales information of compact disc records as music soft wares and their new products is applied as the subject information source. But any other information even if applied does not damage the effect of this invention.

As in the same example, the periodically issued magazines are applied as the subject for retrieval, and the dates of sales, numbers of issue and a part of contents of the magazines retrieved are presumed, but even in the case of setting the names of magazines and transmitting all or apart of the contents or the articles, the effect of this invention is not damaged, which remains unchanged if all or a part of other information is distributed similarly as mentioned above.

Even if information is translated into foreign language and then distributed as a summarization method, the effect of this invention is not damaged, and the same effect can be maintained if service distributors themselves summarize and apply the keywords for retrieval.

In this example of a preferred embodiment. a single word is presumed as a retrieval key word, but the sentences, symbols, voices, pictures, abstract concept, functions, etc. can be used as retrieval key words without damaging the effect of this invention.

Logistical formula of “and ”, “or”, etc. can also be applied for retrieval without damaging the effect of this invention, which is similarly applicable when the retrieval key words accord with categories and relevant factors by which the contents of the magazines are analyzed and signified, and its results are output. In this case fuzzy retrieval of information becomes possible to bring more convenience to the users.

In this example of a preferred embodiment, the data contribution by publishers is applied as the information collection method, but the effect of this invention is the same even if information is contributed by unspecified number of people or other collection method is applied.

In this example of a preferred embodiment, a specific retrieval program is made and applied as a means of retrieval, but even if programming sold in the market, people's eyesight and picture treatment are applied as the retrieval method, the said effect can be the same.

In this example of a preferred embodiment, e-mail is applied as a means of information distribution, but the effect of this invention cannot be damaged even if any method to combine programming and e-mail together, mailing service, facsimile, telephones, home pages, mobile phone terminals, game machines with communication function, wireless, or cable communication equipment, television, and other transmitting means are applied.

In this example of a preferred embodiment, free services are offered to the users or non-providers of information, but chargeable services can be offered without damaging the same effect. And even if information distribution to mobile phone telephones is charged with any collection method of charged fees, the effect of this inventgion is not damaged.

In this example of a preferred embodiment, as a means to obtain information or publications, or to receive further information or services thereof based on the said information or publications, the links or advertisements with description of the internet addresses of internet bookstores and record shops on the provided mail are used, but even if any specific forms for input on the home pages are applied, any purchase forms are attached to the provided mail, the link described on the mail is deemed to have been action order of the program of a start button of direct services, the effect of this invention is not damaged.

In this example of a preferred embodiment, as a means to receive further information or services based on the collected information, the links or advertisements with description of internet addresses of the internet bookstores and record shops on the provided mail are applied, but the effect of this invention is not damaged even in the case that collected and summarized information is re-sold to the information contributors and its users or other people as customers' information for marketing, etc.

It is possible to obtain more effective retrieved and summarized information easily, speedily and at a lower cost by applying the system of this invention or making transaction thereof. It is also possible to make a purchase and choice of the goods or availing of services quite easily, speedily and at a lower cost direct from the information collection means.

Moreover, through usage of the system of this invention or making a transaction thereof, it is possible to contribute more useful individual information arranged for each users, i.e. different information for each users, and thus to collect usage fees, from information distributors, advertisers, advertising agents, and retail shops.

What is claimed is:

1. An apparatus for information distribution system using computer and method for trading using the information distribution system, with application of a means to collect more than a single information or the contents of publications made public or issued regularly or irregularly, a means to make more than a single retrieval of more than a single word or phrase registered in advance out of more than a single information collected by the above method and summarize the result more than once, a means to retrieve and extract more than once more than a single character registered in advance and summarize its result, a means to distribute more than once information collected by the above retrieval, extraction and summarization method through the computer for all or partial application, and with features, to distribute more than once different information collected and summarized more than once by the above method to more than an individual person or group/organization by the above-mentioned contribution method.

2. An apparatus for information distribution system using computer and method for trading using the information distribution system, using the computer of the above claim 1 as a means to distribute more than once data and information collected and summarized by the above-stated retrieval, extraction and summarization method by the computer, or e-mail as a device for cable of wireless transmission of eletronic data or television as a device for cable or wireless data transmission, or home pages as a device for cable or wireless display of electronic data, or cable or wireless telephone or mobile information terminals, or mobile phones as information terminals,in the above claim 1 method.

3. An apparatus for information distribution system using computer and method for trading using the information distribution system, with a means to obtain above-mentioned information or publications themselves to be retrieved or extracted, and a means to obtain further information or make use of services based on the above information or publications, and those features thereof, in the above claim 1 or claim 2 methods.

4. An apparatus for information distribution system using computer and method for trading using the information distribution system, with features to collect information distribution fees of more than zero yen from more than an individual person or group/organizations or providers of information or publications who receive information summarized as above, in the above claim 1 or claim 2 or claim 3 methods.

5. An apparatus for information distribution system using computer and method for trading using the information distribution system, with features not only to attach or add advertisement or publicity to, or on the above information to be transmitted but also to collect more than zero yen as its description fees from the advertisement or publicity providers, in the above claim 1 or claim 2 or claim 3 or claim 4 methods.

6. An apparatus for information distribution system using computer and method for trading using the information distribution system, with features of a computer software device to carry out all or a part of the means by the computer, in the above claim 1 or claim 2 or claim 3 or claim 4 or claim 5 methods.
